(19) United States
(12) Patent Application Publication
(10) Pub. No.: US 2021/0086423 A1
(43) Pub. Date: Mar. 25, 2021

(54) INJECTION MOLDING APPARATUS WITH A THERMAL BRIDGE

(71) Applicant: MOLD-MASTERS (2007) LIMITED, Georgetown (CA)

(72) Inventors: Payman TABASSI, Rockwood (CA); Gurvinder BAJWA, Brampton (CA)

(21) Appl. No.: 17/029,659

(22) Filed: Sep. 23, 2020

Related U.S. Application Data
(60) Provisional application No. 62/904,817, filed on Sep. 24, 2019.

(51) Int. Cl. B29C 45/73; B29C 45/23; B29C 45/27

(52) U.S. Cl. CPC B29C 45/7331; B29C 45/2738; B29C 45/231

(57) ABSTRACT

An injection molding apparatus is disclosed. The injection molding apparatus includes a hot runner system having a manifold for receiving material from a source and a nozzle for delivering molding material received from the manifold to a mold cavity. A valve pin that is connectable to an actuator for translating the valve pin between open and closed positions is slidably received in a valve pin seal at an upstream end of the nozzle. Hot runner system includes a thermal bridge that is in conductive thermal communication with the valve pin seal and, a cooled mold plate.

### CROSS REFERENCE TO RELATED APPLICATION

The present application claims the benefit of prior U.S. Appl. No. 62/904,817, filed Sep. 24, 2019, which is incorporated by reference herein in its entirety.

### TECHNICAL FIELD

The present invention relates to an injection molding apparatus, and in particular, to an injection molding apparatus with a thermal bridge.

### BACKGROUND

Egress of molding material from a hot runner through the interface between a valve pin and a valve pin seal which surrounds the valve pin where the valve pin enters the hot runner system is known in the art of injection molding as valve pin weepage. Valve pin weepage is undesirable.

### SUMMARY

Embodiments hereof are directed towards an injection molding apparatus having a hot runner system. A manifold for receiving material from a source has a manifold channel that extends between a manifold inlet and a manifold outlet. A nozzle for delivering molding material received from the manifold to a mold cavity has a nozzle channel that extends between a nozzle inlet and a nozzle outlet. A valve pin that is connectable to an actuator for translating the valve pin between an open position and a closed position extends through the manifold and the nozzle channel. A valve pin seal at an upstream end of the nozzle has a valve pin bore in communication with the nozzle channel and in which the valve pin is slidably received, and a thermal bridge is in conductive thermal communication with the valve pin seal and a cooled mold plate.

### BRIEF DESCRIPTION OF DRAWINGS

The foregoing and other features and advantages of the invention will be apparent from the following description of embodiments thereof as illustrated in the accompanying drawings. The drawings are not to scale.

FIG. 1 is a sectional view of a portion of an injection molding apparatus having a hot runner system with a thermal bridge in accordance with an embodiment of the present disclosure.

FIG. 2 is an enlarged view of a portion 2 of FIG. 1.

FIG. 3 is a sectional view of the upstream end of a nozzle and a thermal bridge in accordance with another embodiment of the present disclosure and shown installed in a portion of an injection molding system which is similar to portion 2 of the injection molding system of FIG. 1.

FIG. 4 is a sectional view of the upstream end of a nozzle and a thermal bridge in accordance with yet another embodiment of the present disclosure shown installed in a portion of an injection molding system which is similar to portion 2 of the injection molding system of FIG. 1.

### DETAILED DESCRIPTION

In the following description, “downstream” is used with reference to the general direction of molding material flow from an injection unit to a mold cavity of an injection molding system and to the order of components, or features thereof, through which the molding material flows from an inlet of the injection molding system to the mold cavity. “Upstream” is used with reference to the opposite direction. As used herein, the phrase, “conductive thermal communication” refers to components forming a physical pathway, through which heat can travel. Further, there is no intention to be bound by any expressed or implied theory presented in the preceding technical field, background, summary or the following detailed description.

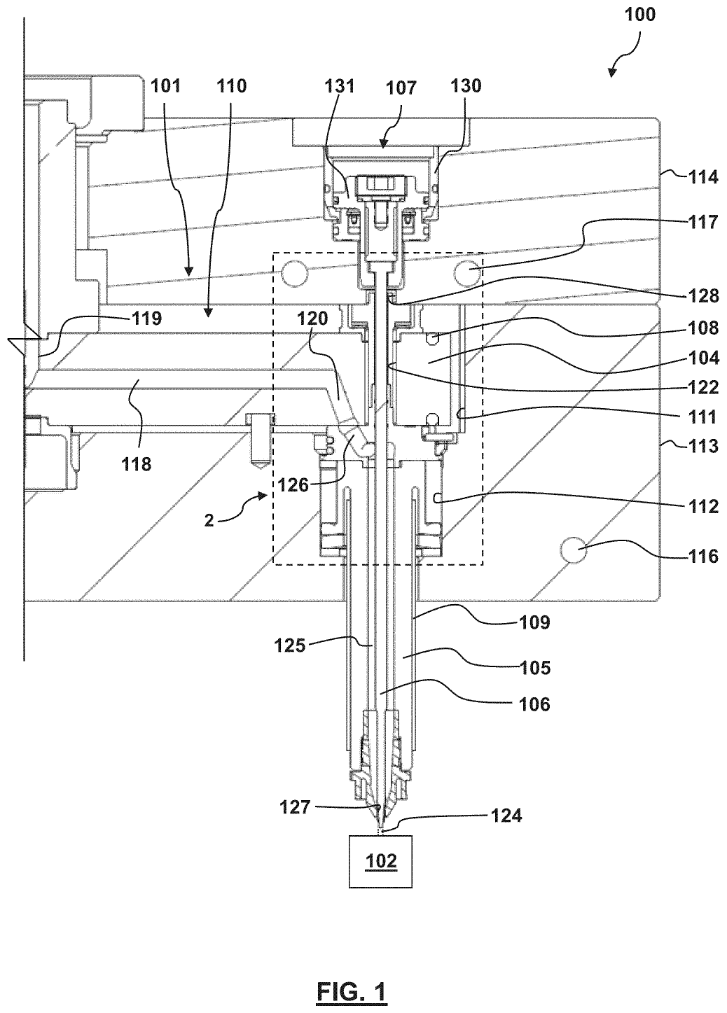

FIG. 1 is a sectional view of a portion of an injection molding apparatus 100 having a hot runner system 101 in accordance with an embodiment of the present disclosure. Hot runner system 101 delivers molding material received from a source, typically an injection molding machine (not shown), to a mold cavity 102 (shown schematically in FIG. 1) which defines the shape of a molded article that is formed in injection molding apparatus 100. Hot runner system 101 includes a manifold 104, a nozzle 105, a valve pin 106, and an actuator 107. Manifold 104 and nozzle 105 include respective manifold and nozzle heaters 108, 109 which, in operation, maintain manifold 104 and nozzle 105 at a suitable processing temperature.

Injection molding apparatus 100 includes a plurality of mold plates which form an enclosure 110 in which hot runner system 101 is received. Enclosure 110 includes a pocket 111 that surrounds manifold 104 and a well 112 that surrounds nozzle 105. As shown, injection molding apparatus 100 includes a first mold plate 113 and a second mold plate 114. Mold plates 113, 114 are held together by fasteners (not shown) and typically include additional fastening/aligning components such as dowels and the like (not shown). While injection molding apparatus 100 is shown having two mold plates 113, 114, injection molding apparatus 100 can include other mold plates. Mold plates 113, 114 include cooling channels, such as cooling channel 116 in first mold plate 113 and cooling channel 117 in second mold plate 114. Cooling fluid is circulated through cooling channels 116, 117 to maintain first and second mold plates 113, 114 at a suitable molding temperature which is less than the operational temperature of manifold 104 and nozzle 105.

Continuing with FIG. 1, manifold 104 includes a manifold channel 118 that extends between a manifold inlet 119 and a manifold outlet 120. In operation, manifold 104 receives molding material from a source, via manifold inlet 119, and delivers it to nozzle 105 via manifold outlet 120. Manifold 104 further includes a valve pin passageway 122 through which valve pin 106 extends. Nozzle 105 delivers molding material to mold cavity 102 via a mold gate 124 (shown schematically in FIG. 1). Nozzle 105 includes a nozzle channel 125 extending between a nozzle inlet 126 and a nozzle outlet 127. Valve pin 106 extends through valve pin passageway 122 and nozzle channel 125. Upstream from manifold 104, valve pin 106 extends through a plate bore 128 in second mold plate 114, and at its upstream end, valve pin 106 is coupled to actuator 107 which translates valve pin 106 between a closed position and an open position. In its closed position, valve pin 106 is positioned to block mold gate 124, which prevents moldable material from entering mold cavity 102. In its open position, valve pin 106 is separated from mold gate 124 to allow molding material to be injected into mold cavity 102. In FIG. 1, valve pin 106 is in its closed position. Actuator 107 includes a stationary part 130 secured to second mold plate 114 and a movable part 131 to which valve pin 106 is coupled to be movable therewith. In the illustrated embodiment, actuator 107 is a fluid driven actuator.

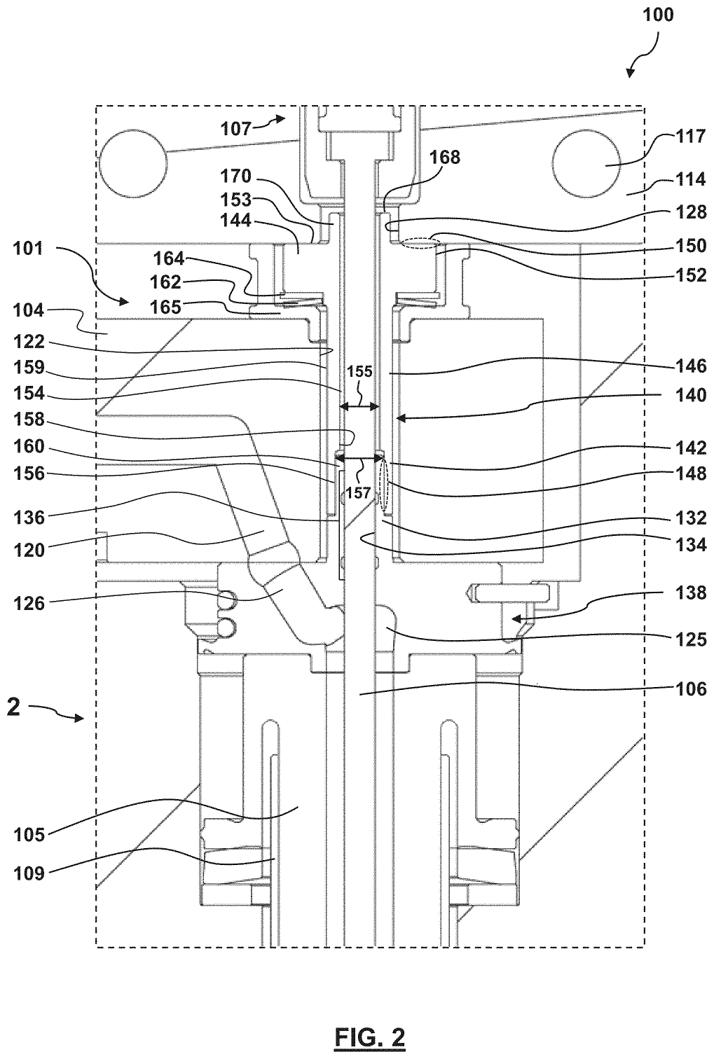

Referring now to FIG. 2 which is an enlarged view of a portion 2 of FIG. 1, an upstream end of nozzle 105 includes a valve pin seal 132. Valve pin seal 132 includes a valve pin bore 134 through which valve pin 106 extends. A sealing interface 136 is a portion of valve pin bore 134 which is sized to slidably mate with valve pin 106 to promote a fluid seal therebetween. At sealing interface 136, valve pin 106 and valve pin bore 134 are closely sized to reduce migration of molding material from nozzle channel 125 through valve pin bore 134. In the current embodiment, valve pin seal 132 is a portion of a bushing component 138 which is a part of nozzle 105 and also defines nozzle channel inlet 126.

In accordance with embodiments hereof, hot runner system 101 includes a thermal bridge 140 that is in conductive thermal communication with valve pin seal 132 and is in conductive thermal communication with second mold plate 114. In operation, thermal bridge 140 conducts heat from valve pin seal 132 to second mold plate 114 which is cooler than valve pin seal 132. Removing heat from valve pin seal 132 helps to maintain the fit between valve pin bore 134 and valve pin 106 which can limit or prevent molding material weepage.

To facilitate heat transfer from valve pin seal 132 to second mold plate 114, thermal bridge 140 is made from a material that is more thermally conductive than the material from which valve pin seal 132 is made. Non-limiting examples of such a material include copper, a copper alloy such as Beryllium Copper or AMPCOLOY 940® (available from AMPCO MATAL S.A. of Marly, Switzerland), molybdenum or a molybdenum alloy, and mold or tool steel, including NAK 55 or FASTCOOL®-50 (available from Rovalma S.A. of Barcelona, Spain).

Thermal bridge 140 extends through valve pin passageway 122 and is thermally insulated from manifold 104. With reference to valve pin seal 132, thermal bridge 140 includes a proximal portion 142 and a distal portion 144 that is longitudinally spaced apart from proximal portion 142 by a medial portion 146. Proximal portion 142 is in conductive thermal communication with valve pin seal 132. A proximal conductive heat transfer area 148 is defined between valve pin seal 132 and proximal portion 142. Distal portion 144 is in conductive thermal communication with second mold plate 114, which in the embodiment shown in FIGS. 1 and 2 is the mold plate to which actuator 107 is secured. A distal conductive heat transfer area 150 is defined between distal portion 144 and second mold plate 114. Distal portion 144 is a part of a lateral portion 152 of thermal bridge 140 which extends radially outward from medial portion 146. Lateral portion 152 includes an abutment surface 153 through which distal portion 144 is in conductive thermal communication with second mold plate 114. In comparison to a version of thermal bridge 140 without a lateral portion 152, the size of the surface area of distal heat transfer area 150 is increased, which can improve the effectiveness of thermal bridge 140.

Proximal portion 142 longitudinally overlaps valve pin seal 132, which creates a longitudinally extending proximal heat transfer area 148 between thermal bridge 140 and valve pin seal 132. In the illustrated embodiment of FIGS. 1 and 2, thermal bridge 140 longitudinally overlaps valve pin seal 132 and is in conductive thermal communication with valve pin seal 132 along an area that at least partially overlaps sealing interface 136. Thermal bridge 140 includes a longitudinally extending opening 154, for example, a bore that extends therethrough. A length of an outer surface 156 of valve pin seal 132 is in conductive thermal communication with a wall 158 of opening 154. Opening 154 also serves as a collection area into which molding material is deposited should molding material migrate through sealing interface 136.

Continuing with FIGS. 1 and 2, opening 154 includes a first portion 155 having a first diameter and a second portion 157 having a second diameter. First portion 155 is sized to be thermally insulated from valve pin 106 by, for example an air gap between wall 158 of opening 154 and valve pin 106. The diameter of second portion 157 is larger than the diameter of the first portion 155 and is sized for conductive thermal communication with valve pin seal 132. An outer surface 159 of thermal bridge 140 is thermally insulated from valve pin passageway 122 by, for example an air gap. Also shown in the illustrated embodiment of FIGS. 1 and 2, the upstream end of valve pin seal 132 includes a reduced wall thickness portion 160. Second portion 157 and reduced thickness portion 160 are sized relative to each other so that reduced wall thickness portion 160 is in conductive thermal communication with thermal bridge 140.

Opening 154 having two differently sized portions 155, 157 in combination with reduced wall thickness portion 160 help to reduce the overall space required to accommodate thermal bridge 140 while maintaining sufficient wall thickness of thermal bridge 140 to sufficiently conduct heat to second mold plate 114, in an alternative embodiment (not shown) opening 154 is shaped as a straight bore that extends through thermal bridge 140 which is thermally insulated from valve pin 106, and sized for conductive thermal communication with valve pin seal 132.

Engagement between valve pin seal 132 and wall 158 creates a proximal heat transfer area 148 that surrounds valve pin seal 132. This configuration allows heat to be conducted away from around the circumference of outer surface 156 of valve pin seal 132, which may be beneficial for evenly affecting the temperature of valve pin bore around the perimeter of valve pin 106; however, in applications in which it might be beneficial to draw heat away from a specific side or portion of valve pin seal 132, it may be beneficial for thermal bridge 140 and valve pin seal 132 to be in conductive thermal communication only partially around valve pin seal 132 which would create a proximal heat transfer area 148 that partially surround valve pin seal 132.

Thermal bridge 140 is mounted within injection molding apparatus 100 to permit longitudinal displacement of valve pin seal 132 relative to second mold plate 114 which may occur as a result of, for example, thermal expansion of nozzle 105. One way of accomplishing this is to mount thermal bridge 140 so that it is longitudinally fixed in position relative to one of valve pin seal 132 and second mold plate 114 while being longitudinally displaceable relative to the other of the valve pin seal 132 and second mold plate 114.

In the illustrated embodiment of FIGS. 1 and 2, distal portion 144 is longitudinally fixed in position relative to second mold plate 114. To facilitate this, hot runner system 101 includes a biasing member 162, for example a Bellville washer, disposed between lateral portion 152 and manifold 104. In operation, biasing member 162 is energized and bears against manifold 104 to urge lateral portion 152 into conductive thermal communication with second mold plate 114 to form a rigid abutting connection therebetween. Other types of rigid connections between distal portion 144 and second mold plate 114 are contemplated for embodiments disclosed herein, including a threaded connection, a bayonet connection, and an interference connection. Regarding valve pin seal 132, wall 158 of opening 154 is slidably engaged with outer surface 156 of valve pin seal 132 to permit longitudinal displacement of valve pin seal 132 relative to second mold plate 114.

In embodiments that include a biasing member 162 which abuts thermal bridge 140 into conductive thermal communication with second mold plate 114, hot runner system 101 can include a wear pad 164, for example, a washer as shown in FIG. 2, disposed between biasing member 162 and the area on thermal bridge 140, e.g. lateral portion 152, upon which biasing member 162 acts, which may prevent marring of thermal bridge 140. Further, hot runner system 101 can include another wear pad 165 disposed between biasing member 162 and the area on manifold 104 against which biasing member 162 acts to prevent marring of manifold 104.

Continuing with FIG. 2, lateral portion 152 is longitudinally spaced apart from a distal end 168 of thermal bridge 140. In this this configuration, thermal bridge 140 includes a head portion 170 that projects into second mold plate 114. Head portion 170 increases the length of opening 154 which lengthens the collection area into which molding material may be deposited. Since head portion 170 is adjacent to distal portion 144, the temperature of opening 154 is relatively cool adjacent to actuator 107, which reduces the likelihood of molding material from migrating to actuator 107.

Head portion 170 can be spaced apart from plate bore 128 as is shown. Alternatively, head portion 170 is sized relative to plate bore 128 to establish conductive thermal communication therebetween which increases the size of the surface area of distal heat transfer area 150 and laterally locates thermal bridge 140 relative to second mold plate 114.

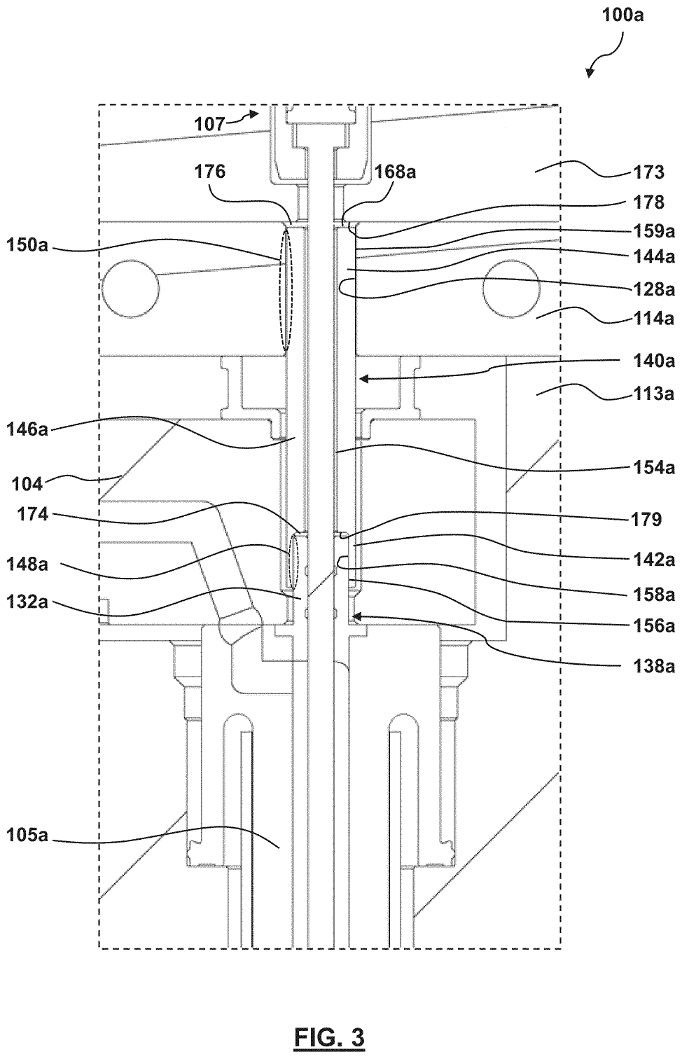

Referring now to FIG. 3 which is a sectional view of the upstream end of a nozzle 105a and a thermal bridge 140a in accordance with another embodiment of the present disclosure shown installed in a portion of an injection molding system 100a which is similar to portion 2 of injection molding system 100 of FIG. 1. Features and aspects of the other embodiments can be used with the present embodiment. In the current embodiment thermal bridge 140a is in conductive thermal communication with second mold plate 114a at plate bore 128a. Thermal bridge 140a can be described as sleeve shaped and includes a proximal portion 142a and a distal portion 144a that is spaced apart from proximal portion by a medial portion 146a. Distal portion 144a is in conductive communication with second mold plate 114a. A distal heat transfer area 150a is formed between an outer surface 159a of thermal bridge 140a, at distal portion 144a, and plate bore 128a which extends through second mold plate 114a. In the present embodiment, second mold plate 114a is an intermediate mold plate that is sandwiched between first mold plate 113a and a third mold plate 173 to which actuator 107 is secured. Proximal portion 142a is in conductive thermal communication with valve pin seal 132a. A proximal heat transfer area 148a is defined between outer surface 156a of valve pin seal 132a and wall 158a of opening 154a in thermal bridge 140a. In the current embodiment valve pin seal 132a is a bushing component 138a that is received in the upstream end of nozzle 105a.

Thermal bridge 140a is mounted within injection molding apparatus 100a to permit longitudinal displacement of valve pin seal 132a relative to second mold plate 114a. In one example, distal portion 144a is longitudinally fixed in position relative to second mold plate 114a by, for example a threaded connection between outer surface 159a of thermal bridge 140a, at distal portion 144a, and plate bore 128a, and proximal portion 142a is longitudinally slidable relative to valve pin seal 132a by, for example, a slide fit connection between outer surface 156a of valve pin seal 132a and wall 158a of opening 154a. In this configuration a gap 174, is provided between valve pin seal 132a and thermal bridge 140a which accommodates longitudinal displacement of valve pin seal 132a relative to thermal bridge 140a. Alternatively, proximal portion 142a can be longitudinally fixed in position relative to valve pin seal 132a by, for example a threaded connection between outer surface 156a of valve pin seal 132a and wall 158a of opening 154a, and distal portion 144a is longitudinally slidable relative to second mold plate 114a by, for example, a slide fit connection between outer surface 159a of thermal bridge 140a at distal portion 144a and plate bore 128a.

In this configuration a gap, shown at location 176, is provided between distal end 168a of thermal bridge 140a and the downstream side 178 of third mold plate 173 which accommodates longitudinal displacement of valve pin seal 132a and thermal bridge 140a relative to third mold plate 173.

In another example, longitudinal displacement of valve pin seal 132a relative to second mold plate 114a is accommodated by slidably engaging thermal bridge 140a with valve pin seal 132a and with second mold plate 114a. For example, thermal bridge 140a is slidably engaged with second mold plate 114a by, for example, a slide fit connection between outer surface 159a of thermal bridge 140a at distal portion 144a and plate bore 128a and proximal portion 142a is slidably engaged with valve pin seal 132a by, for example, a slide fit connection between outer surface 156a of valve pin seal 132a and wall 158a of opening 154a. In such a configuration thermal bridge 140a is longitudinally displaceable relative to both valve pin seal 132a and second mold plate 114a. Longitudinal movement of valve pin seal 132a is accommodated by gap 174, between valve pin seal 132a and thermal bridge 140a and gap 176, between thermal bridge 140a and third mold plate 173. The amount of longitudinal movement of thermal bridge 140a is limited by boundary surfaces such as downstream side 178 of third mold plate 173 and a step 179 in opening 154a in order to maintain conductive thermal communication between valve pin seal 132a and third mold plate 173 via thermal bridge 140a.

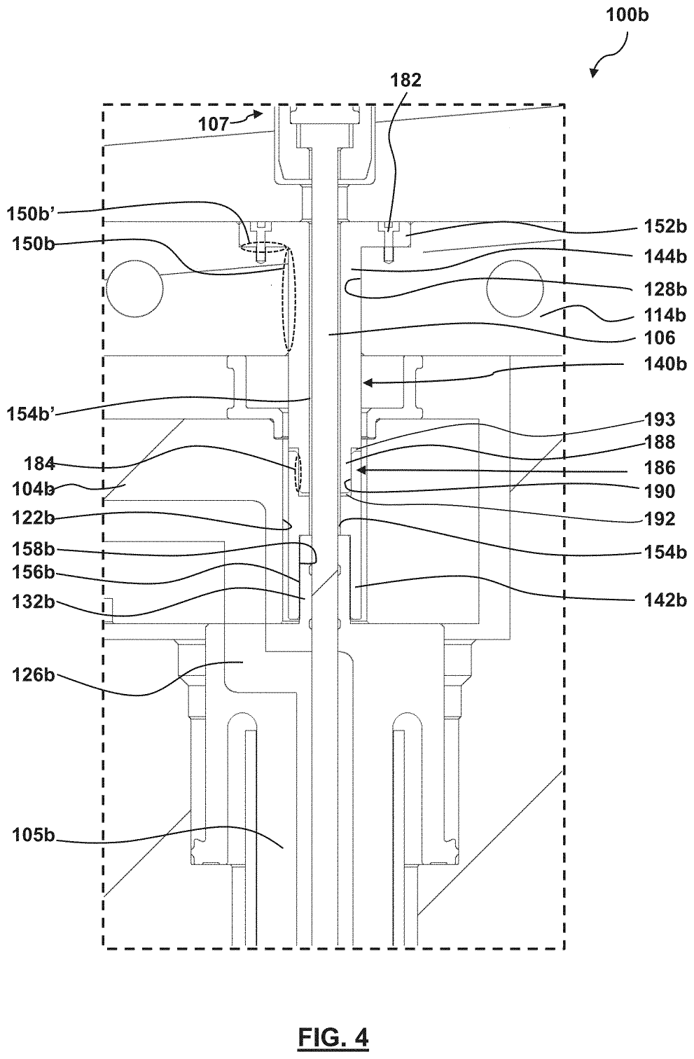

Referring now to FIG. 4 which is a sectional view of the upstream end of a nozzle 105b and a thermal bridge 140b in accordance with another embodiment of the present disclosure, shown installed in a portion of an injection molding system 100b, which is similar to portion 2 of injection molding system 100 of FIG. 1. Features and aspects of the other embodiments can be used with the present embodiment. Thermal bridge includes discrete proximal and distal portions 142b, 144b. Distal portion 144b is in conductive communication with second mold plate 114b and proximal portion 142b is in conductive thermal communication with valve pin seal 132b. A proximal component opening 154b extends longitudinally through proximal portion 142b and a distal component opening 154b′ extends longitudinally through distal portion 144b; valve pin 106 passes through both proximal and distal portion openings 154b, 154b′. In the current embodiment valve pin seal 132b is a unitary portion of nozzle 105b, as is nozzle channel inlet 126b.

Distal portion 144b is rigidly coupled to second mold plate 114b and extends through plate bore 128b in second mold plate 114b and into valve pin passageway 122b in manifold 104b. As shown in FIG. 4, distal portion 144b includes a lateral portion 152b that is in conductive thermal communication with second mold plate 114b. As shown, fasteners 182 secure distal portion 144b to second mold plate 114b. Alternatively (not shown), distal portion 144b is secured in place by clamping lateral portion 152b between second mold plate 114b and third mold plate 173 to create an abutment connection between thermal bridge 140b and second mold plate 114b. A first distal heat transfer area 150b is defined between distal portion 144b and plate bore 128b and a second distal heat transfer area 150b′ is defined between lateral portion 152b and second mold plate 114b. Proximal portion 142b is rigidly coupled to valve pin seal 132b by, for example a threaded connection created by complementary threads on outer surface 156b of valve pin seal 132b and a wall 158b of proximal portion opening 154b. Proximal portion 142b is in conductive thermal communication with distal portion 144b at a medial heat transfer area 184 that is defined by a telescopic connection 186 between distal portion 144b and proximal portion 142b. Telescopic connection 186 is realized by a plug 188 that projects from distal portion 144b and is slidably received in a complementary socket 190 in proximal portion 142b. Distal portion 144b and proximal portion 142b are sized to form longitudinal gaps 192, 193 which accommodate longitudinal displacement of proximal portion 142b as a result of longitudinal displacement of valve pin seal 132b that may occur because of lengthwise thermal expansion of nozzle 105b. Telescopic connection 186 can also be realized by providing proximal portion 142b with a plug 188 which is slidably received in a complementary socket 190 in distal portion 144b (not shown).

Proximal and distal portions 142b, 144b can be made from the same material, for example copper or a copper alloy, or can be made from different materials. For example, the portion of thermal bridge 140b having socket 190, i.e. proximal portion 142b in FIG. 4, can be made from molybdenum or a molybdenum alloy, and the portion of thermal bridge 140b having plug 188, i.e. distal portion 144b in FIG. 4 can be made from copper or a copper alloy. In this example, due to the different thermal expansion rates of molybdenum materials and copper materials, thermal expansion across socket 190 is less than thermal expansion across plug 188. This material combination results in a closer fit between plug 188 and socket 190 when injection molding apparatus 100b is in operation compared to when injection molding apparatus 100b is assembled and not in operation. This arrangement facilitates assembly of thermal bridge 140b and promotes conductive thermal communication across medial heat transfer area 184.

While various embodiments have been described above, they are presented only as illustrations and examples, and not by way of limitation. Thus, the present invention should not be limited by any of the above-described embodiments but should be defined only in accordance with the appended claims and their equivalents.

What is claimed is:

1. An injection molding apparatus comprising:
a hot runner system having
a manifold for receiving material from a source, the manifold having a manifold channel extending between a manifold inlet and a manifold outlet;
a nozzle for delivering molding material received from the manifold to a mold cavity, the nozzle having a nozzle channel extending between a nozzle inlet and a nozzle outlet;
a valve pin connected to an actuator for translating the valve pin between an open position and a closed position, the valve pin extending through the manifold and the nozzle channel;
a valve pin seal at an upstream end of the nozzle, the valve pin seal having a valve pin bore in which the valve pin is slidably received, the valve pin bore in communication with the nozzle channel; and
a thermal bridge extending through a valve pin passageway in the manifold, the thermal bridge being in conductive thermal communication with the valve pin seal, and when the injection molding apparatus is assembled, is in conductive thermal communication with a cooled mold plate.

2. The injection molding apparatus of claim 1, wherein the thermal bridge longitudinally overlaps the valve pin seal to create a longitudinally extending conductive heat transfer area between the thermal bridge and the valve pin seal.

3. The injection molding apparatus of claim 2, wherein a first conductive heat transfer area between the thermal bridge and the valve pin seal at least partially overlaps a sealing engagement portion of the valve pin bore.

4. The injection molding apparatus of claim 1, wherein a conductive heat transfer area between the thermal bridge and the valve pin seal at least partially surrounds the valve pin seal.

5. The injection molding apparatus of claim 4, wherein the thermal bridge includes a longitudinally extending opening having a wall, and a length of an outer surface of the valve pin seal is in conductive thermal communication with the wall of the opening.

6. The injection molding apparatus of claim 5, wherein the opening is a cylindrical bore, the cylindrical bore including a first portion having a first diameter, the first portion of the cylindrical bore being thermally insulated from the valve pin.

7. The injection molding apparatus of claim 6, wherein the cylindrical bore includes a second portion having a second diameter larger than the first diameter, wherein a wall of the second diameter portion is in conductive thermal communication with the outer surface of the valve pin seal.

8. The injection molding apparatus of claim 1, wherein the thermal bridge is thermally insulated from the valve pin by an air gap that surrounds the valve pin.

9. The injection molding apparatus of claim 1, wherein the thermal bridge includes an inner surface that is in conductive thermal communication with an outer surface of the valve pin seal.

10. The injection molding apparatus of claim 9, wherein the thermal bridge includes a lateral portion, in operation, the lateral portion is in conductive thermal communication with the cooled mold plate.

11. The injection molding apparatus of claim 10 further comprising:
a biasing member disposed between the lateral portion and the manifold, in operation the biasing member urging the lateral portion towards the cooled mold plate.

12. The injection molding apparatus of claim 9, wherein, in operation, an outer surface of the thermal bridge is in conductive thermal communication with a bore in the cooled mold plate.

13. The injection molding apparatus of claim 1, wherein the thermal bridge is longitudinally fixed in position relative to one of the valve pin seal and the cooled mold plate and is longitudinally slidable relative to the other of the valve pin seal and the cooled mold plate.

14. The injection molding apparatus of claim 13, wherein the thermal bridge is longitudinally fixed in position relative to the cooled mold plate and the valve pin seal is slidably received in the thermal bridge.

15. The injection molding apparatus of claim 14, wherein longitudinally fixed includes a connection between the thermal bridge and the cooled mold plate by way of at least one of an interference connection, a threaded connection, a bayonet connection, and an abutment connection.

16. The injection molding apparatus of claim 13, wherein, the thermal bridge is longitudinally fixed in position around the valve pin seal and is longitudinally slidable within a bore in the cooled mold plate.

17. The injection molding apparatus of claim 16, wherein longitudinally fixed includes a connection between the thermal bridge and the valve pin seal by way of at least one of an interference connection, a threaded connection, a bayonet connection, and an abutting connection.

18. The injection molding apparatus of claim 1, wherein the size of a surface area of a first conductive heat transfer area between the thermal bridge and the cooled mold plate is greater than the size of a surface area of a second conductive heat transfer area between the thermal bridge and the valve pin seal.

19. The injection molding apparatus of claim 1, wherein the thermal bridge includes a proximal portion fixed in position relative to the valve pin seal and a distal portion fixed in position relative to the cooled mold plate, wherein the proximal portion is in conductive thermal communication with the distal portion by a telescopic connection between the proximal portion and the distal portion.

20. The injection molding apparatus of claim 1, wherein the thermal bridge is made from a material that is more thermally conductive than a material from which the valve pin seal is made.
